(19) United States
(12) Patent Application Publication
(10) Pub. No.: US 2026/0310182 A1
(43) Pub. Date: Oct. 8, 2026

(54) ARTICLE INSPECTION DEVICE, MAINTENANCE MANAGEMENT METHOD FOR ARTICLE INSPECTION DEVICE, AND MAINTENANCE MANAGEMENT SYSTEM FOR ARTICLE INSPECTION DEVICE

(71) Applicant: ANRITSU CORPORATION, Kanagawa (JP)

(72) Inventors: Takeshi TSUNODA, Kanagawa (JP); Kazunori NAKAYAMA, Kanagawa (JP); Naoya SAITO, Kanagawa (JP)

(21) Appl. No.: 19/640,483

(22) Filed: Apr. 7, 2026

(30) Foreign Application Priority Data
Apr. 8, 2025 (JP) 2025-063829

(51) Int. Cl. G05B 19/418

(52) U.S. Cl. CPC G05B 19/4184; G05B 19/4183

(57) ABSTRACT

An article inspection device includes: an internal database that stores maintenance management data including identification codes of a plurality of main parts, which constitute the article inspection device and are to be maintained, in association with a machine number which is device identification information of a device shipped from a manufacturer; and a control unit that displays and outputs the plurality of main parts so as to be selectable as mounted maintenance target parts associated with the machine number, based on the maintenance management data stored in the internal database, when display output of the maintenance management data is requested.

### Technical Field

The present invention relates to an article inspection device, a maintenance management method for the article inspection device, and a maintenance management system for the article inspection device, and particularly relates to an article inspection device, a maintenance management method for the article inspection device, and a maintenance management system for the article inspection device in which replacement of a consumable part or replacement of a deteriorated or defective maintenance part can be executed in an installation environment.

### Background Art

In the related art, article inspection devices are widely used that inspect articles being transported, for example, the presence or absence of a contained foreign matter or a missing article, the excess or deficiency in the size or weight of contents, the appropriateness of a packaging state, and the like.

This article inspection device is installed in a production line for mass-producing articles such as food. Therefore, even when the main functional parts wear out or fail, it is necessary to replace the main functional parts in a short time and thus to suppress the downtime of the production line for maintenance to a short time.

As this type of article inspection device, for example, a measurement device that is frequently used for food inspection is known, in which consumable parts in a movable unit and the like are stored as the main maintenance parts in storage means at the time of shipment and, when the mode is switched from a normal inspection operation mode to a consumable/maintenance part display mode, it is possible to display and output information such as order codes of the main maintenance parts (for example, see Patent Document 1).

### Related Art Document

### Patent Document

Patent Document 1 JP-A-H07-270220

### DISCLOSURE OF THE INVENTION

### Problem that the Invention is to Solve

However, in many cases, the article inspection device according to the related art is customized to a form or function satisfying the specifications required by the production line, and the main maintenance parts are replaced with parts different from standard parts and shipped. Therefore, even when a user orders necessary main maintenance parts with reference to the operation manual or instruction manual of the article inspection device, the order may be incorrect because the main maintenance parts have been replaced with parts different from the standard parts, and a manufacturer may not quickly and accurately respond to a maintenance request of the user.

In addition, in the customized article inspection device, when the maintenance parts are ordered from the manufacturer, the order may be placed using a user-specific purchase order or in an ordering format that makes it difficult to specify the maintenance parts, and the manufacturer needs to specify the necessary maintenance parts while responding to various ordering formats. For this reason, the manufacturer may not quickly and accurately respond to the maintenance request of the user.

Accordingly, an object of the present invention is to provide an article inspection device, a maintenance management method for the article inspection device, and a maintenance management system for the article inspection device that can quickly and accurately respond to a maintenance request of a user.

### Means for solving the problem

As an example of an embodiment of the present invention, there is provided an article inspection device that measures a predetermined physical quantity of an article and inspects a quality state of the article based on a measured value of the physical quantity. The article inspection device includes: a display operation unit; a maintenance management data storage unit that stores maintenance management data including part identification codes of a plurality of main parts, which constitute the article inspection device and are to be maintained, in association with a machine number which is device identification information of a device shipped from a manufacturer; and a control unit that causes the display operation unit to display and output the plurality of main parts so as to be selectable as mounted maintenance target parts associated with the machine number, based on the maintenance management data stored in the maintenance management data storage unit, when display output of the maintenance management data is requested.

With this configuration, even when any main part is customized to a part other than a standard part according to the requirement specifications of the article inspection device, a user can easily and reliably understand a worn or deteriorated consumable part or other parts that need to be replaced. Therefore, incorrect orders are reliably prevented. In addition, the main parts referred to here are, for example, transport belts and rollers with different materials and sizes, transport drive motors, other mounted parts of different types, conveyors that are installed to extend, and the like. When a sorting machine is installed, the main parts can include main parts of the sorting machine.

As an example of the embodiment of the present invention, the control unit may include: maintenance request information generation means for generating maintenance request information associated with the machine number, using a part identification code of a main part selected from the plurality of main parts being displayed and output on the display operation unit; and maintenance request information output means for transmitting and outputting the maintenance request information associated with the machine number from a communication port capable of performing maintenance communication. Here, the maintenance request information associated with the machine number may include, for example, a display image of a two-dimensional code that can be read by an information terminal or the like, and may specify a network address that enables connection to an electronic commerce (EC) site or a support service communication node on the manufacturer side by the reading of the code.

As an example of the embodiment of the present invention, the maintenance management data storage unit may store picking data used to pick the plurality of main parts when the device is assembled at the manufacturer so as to be readable as the maintenance management data of the plurality of main parts and may store the picking data as read-only information. In this case, the picking data may be stored as the maintenance management data of the plurality of main parts in the maintenance management data storage unit, and writing may be performed on the maintenance management data storage unit via the communication port. The writing may be performed via a communication network.

As an example of the embodiment of the present invention, the control unit may connect the maintenance request information output means to a support service communication node of the manufacturer via the communication port and cause the maintenance request information output means to transmit and output the maintenance request information associated with the machine number, for the main part selected from the plurality of main parts, to the support service communication node.

As an example of the embodiment of the present invention, a transmission intensity distribution of X-rays transmitted through the article may be measured as the predetermined physical quantity of the article. Of course, the article inspection device is not limited to the X-ray inspection type and may be a metal detection type that measures a change in magnetic field during the passage of the article, a weighting type that measures a load corresponding to the weight of the article during the passage of the article, an appearance inspection type based on a camera image, or the like.

As an example of an embodiment of the present invention, there is provided a maintenance management method for an article inspection device that measures a predetermined physical quantity of an article and inspects a quality state of the article based on a measured value of the physical quantity. The maintenance management method for an article inspection device includes: a maintenance management data storage step of storing maintenance management data of a plurality of main parts at a time of assembly at a manufacturer of the article inspection device in a non-volatile memory provided inside the article inspection device in association with a machine number which is device identification information of a device shipped from the manufacturer; a specific part identification data generation step of generating, when an operation of selecting a specific main part from the plurality of main parts in the article inspection device as a maintenance target part is input, specific part identification data capable of uniquely identifying the specific main part selected as the maintenance target part, based on the maintenance management data stored in the non-volatile memory in association with the machine number in the maintenance management data storage step; and an order information output step of transmitting and outputting part order information using the specific part identification data and the machine number associated with the maintenance management data from the article inspection device to a support service communication node on a side of the manufacturer.

With this configuration, even when any main part is customized to a part other than a standard part according to the requirement specifications of the article inspection device, a user can easily and reliably understand a worn or deteriorated consumable part or other parts that need to be replaced. Therefore, the output (ordering) of incorrect order information is reliably prevented.

As an example of the embodiment of the present invention, the maintenance management method for an article inspection device may further include: a received order information generation step of acquiring the machine number and the specific part identification data associated with the machine number when the support service communication node on the side of the manufacturer receives the part order information as input and generating received order information corresponding to the part order information when the acquired machine number and specific part identification data are included in a service machine number and service part identification data stored in a service part management database provided on the side of the manufacturer; and a shipment determination step of determining shipment of a maintenance part having the same specifications as the specific maintenance part equipped in the article inspection device specified by the machine number, based on the machine number and the specific part identification data included in the received order information.

As an example of an embodiment of the present invention, there is provided a maintenance management system for an article inspection device that measures a predetermined physical quantity of an article and inspects a quality state of the article based on a measured value of the physical quantity. The maintenance management system includes: a maintenance management data input unit that stores maintenance management data of a plurality of main parts at a time of assembly at a manufacturer of the article inspection device as maintenance management data associated with a machine number, which is device identification information of a device shipped from the manufacturer, in a non-volatile memory provided inside the article inspection device and in a maintenance management database on a side of the manufacturer; a specific part identification data generation unit that generates, when an operation of selecting a specific main part from the plurality of main parts as a maintenance target part is input via the article inspection device, specific part identification data capable of uniquely identifying the specific main part selected as the maintenance target part, based on the maintenance management data stored in association with the machine number; an order information output unit that transmits and outputs part order information using the specific part identification data and the machine number associated with the maintenance management data from the article inspection device to a support service communication node on a side of the manufacturer; a received order information generation unit that acquires the machine number and the specific part identification data associated with the machine number when the support service communication node on the side of the manufacturer receives the part order information as input and generates received order information corresponding to the part order information when the acquired machine number and specific part identification data are included in a service machine number and service part identification data stored in a service part management database provided on the side of the manufacturer; and a shipment determination unit that determines shipment of a maintenance part having the same specifications as the specific maintenance part equipped in the article inspection device specified by the machine number, based on the machine number and the specific part identification data included in the received order information.

With this configuration, even when any main part is customized to a part other than a standard part according to the requirement specifications of the article inspection device, a user can easily and reliably understand a worn or deteriorated consumable part or other parts that need to be replaced. Therefore, incorrect orders are reliably prevented.

### Advantage of the Invention

According to the present invention, it is possible to provide an article inspection device, a maintenance management method for the article inspection device, and a maintenance management system for the article inspection device that can quickly and accurately respond to a maintenance request of a user.

### BRIEF DESCRIPTION OF THE DRAWINGS

FIG. 1 is a schematic diagram showing a configuration of a maintenance management system for an article inspection device according to an embodiment of the present invention.

FIG. 2 is a schematic diagram showing a configuration of an article inspection device according to an embodiment of the present invention.

FIG. 3 is an explanatory diagram showing a maintenance management parts list display screen that is requestable for display in a maintenance mode in the article inspection device according to the embodiment of the present invention.

FIG. 4 is an explanatory diagram showing a procedure of creating a maintenance management parts list that can be displayed in the maintenance mode in the article inspection device according to the embodiment of the present invention.

FIG. 5 is an exploded perspective view showing main parts to be maintained and managed in the article inspection device according to the embodiment of the present invention.

FIG. 6 is a flowchart showing a rough operation procedure in a maintenance management method for an article inspection device according to an embodiment of the present invention.

### BEST MODE FOR CARRYING OUT THE INVENTION

Hereinafter, embodiments of the present invention will be described with reference to the drawings.

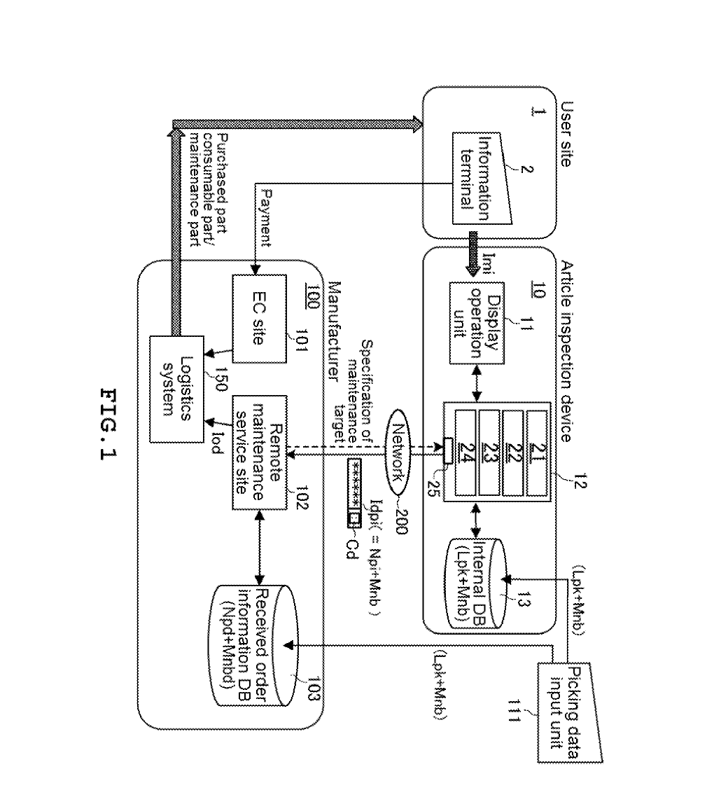

FIGS. 1 - 6 show an article inspection device according to an embodiment of the present invention.

First, a configuration will be described.

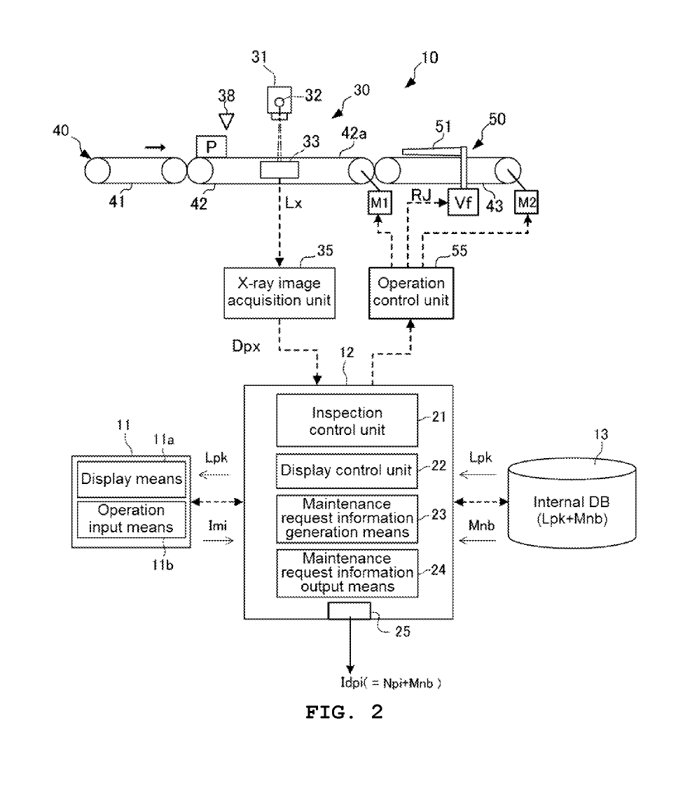

As shown in FIGS. 1 and 2, an article inspection device 10 according to the present embodiment includes a display operation unit 11 that has display means 11a and operation input means 11b, a control unit 12 having an inspection control unit 21 that executes control of article inspection for measuring a predetermined physical quantity of a transported article P and inspecting a quality state of the article P based on a measured value of the physical quantity, and an internal database (DB) 13 that exhibits a database function of accumulating and storing information related to the result of the article inspection.

The article inspection device 10 includes a transport unit 40 that transports the article P to be inspected with predetermined conveyors 41, 42, and 43, an inspection unit 30 that performs predetermined image processing on an article image Dpx obtained by imaging the article P in a transport path of the transport unit with X-rays with the inspection control unit 21 to inspect the quality state of the article P, a sorting unit 50 that operates in response to a sorting command signal RJ corresponding to the inspection result of the quality state and sorts the inspected article P inspected by the inspection unit 30 in a discharge direction corresponding to the inspection result, and the control unit 12 that controls the transport unit 40, the inspection unit 30, and the sorting unit 50.

The display operation unit 11 is, for example, a touch panel type. The display means 11a is configured by a display function of the display operation unit 11, and the operation input means 11b is configured by a touch panel operation input function of the display operation unit 11. In addition, the display operation unit 11 is communicatively connected to the control unit 12 such that it can perform data communication with the control unit 12, together with a tablet information terminal 2 (maintenance part management input means) of a user site 1 that has a communication function and a code reading function.

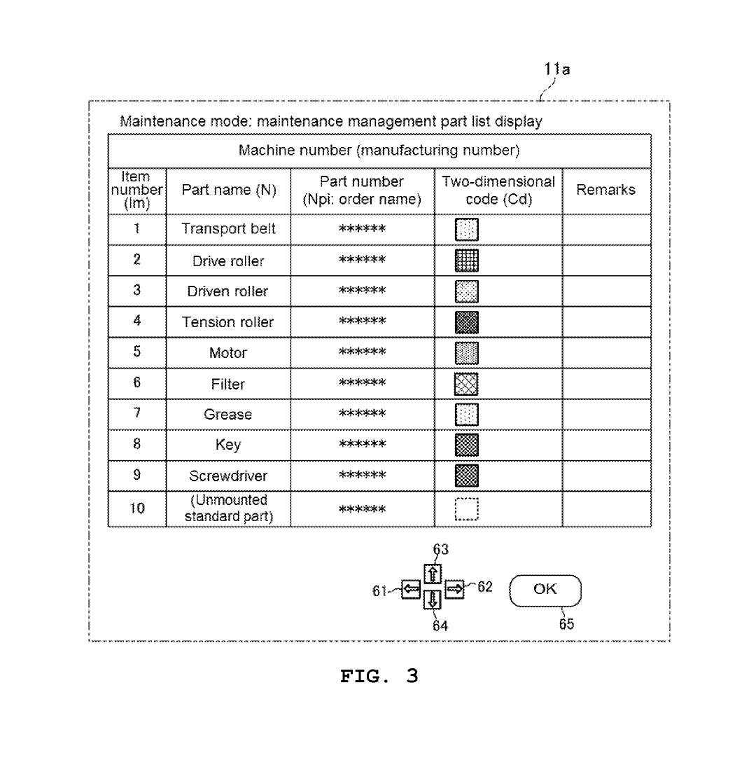

The control unit 12 has a function of a display control unit 22 that displays and outputs, when a request to display a list of information of a plurality of main maintenance target items (main parts) of the article inspection device 10, for example, a part identification code Npi or a part name N shown in FIG. 3, that is, a request to display and output a list equivalent to a parts list is made in response to the input of information from the tablet information terminal 2 of the user site 1 or the input of a touch panel operation from the operation input means 11b, a plurality of main parts P1 to P9 such that the parts can be alternatively selected using the maintenance target item as item number Im, based on maintenance management data Lpk stored in the internal DB 13, as shown in FIG. 3.

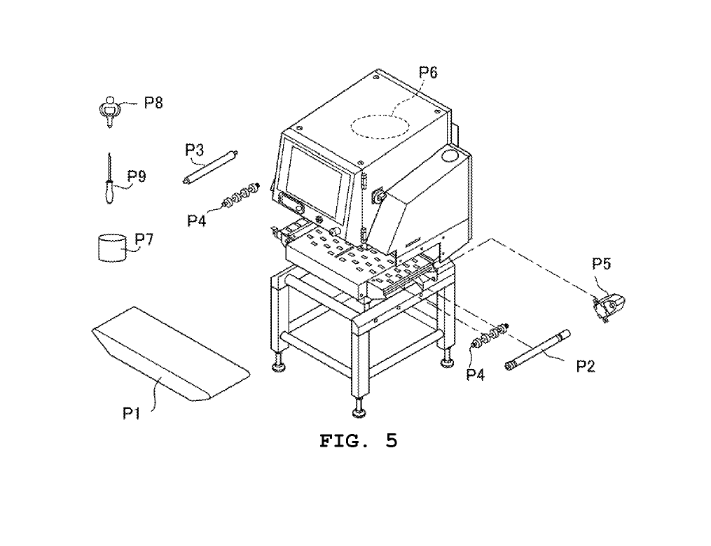

The plurality of main parts P1 to P9 referred to here are a specific number of part items subject to maintenance due to the possibility of wear or failure among a large number of parts constituting the article inspection device 10, are not limited to, for example, parts mounted (attached) on the article inspection device 10 as shown in FIG. 5, and can include accessory parts, peripheral parts, and the like that are used daily in the article inspection device 10.

The part identification code Npi is part identification information corresponding to a part number or an identifiable order name used for ordering each of the main parts P1 to P9 as service parts, and is stored in the internal DB 13 as part data Idpi (i is a natural number corresponding to the item number of the part item) for each part item together with a machine number Mnb (manufacturing number) of the article inspection device 10 which is device identification information of the device shipped from a manufacturer.

In addition, a two-dimensional code Cd that corresponds to a specific network address for each part item identified by the part identification code Npi, such as a part number, for example, an electronic commerce (EC) site 101 or a remote maintenance service site 102, which is a support service communication node on the manufacturer side of the article inspection device 10 is incorporated in the part data Idpi for each part item. Therefore, the part data Idpi that enables unique identification of each part by the part identification code Npi and enables communication connection to the support service communication node on the manufacturer side is stored in the internal DB 13 for each item of the plurality of main parts P1 to P9.

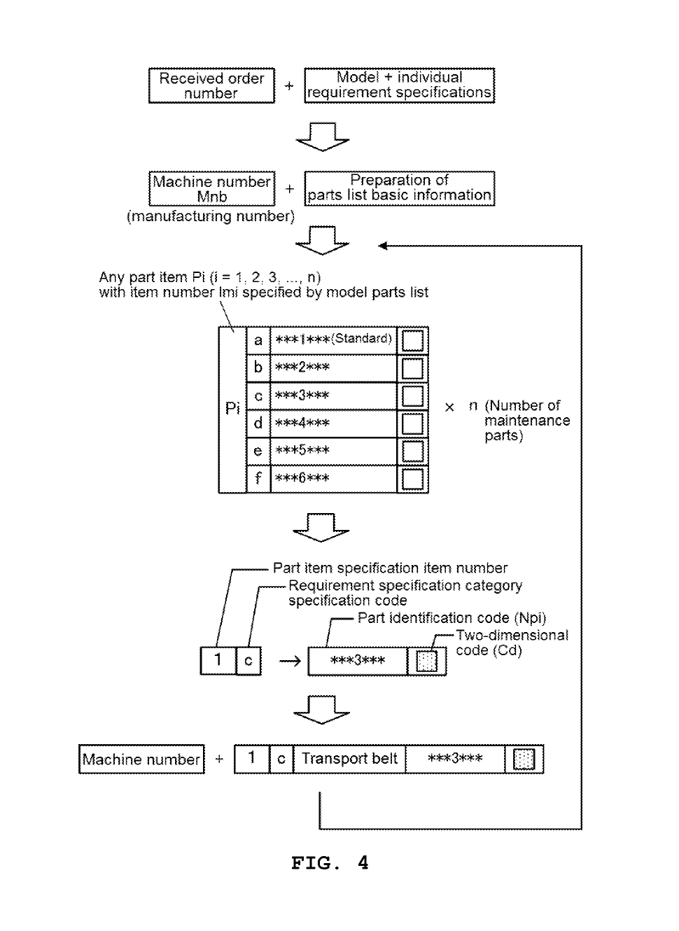

Specifically, as shown in FIG. 4, the model and user requirement specifications of the article inspection device 10 are specified based on information of the model and user requirement specifications of the article inspection device 10 included in received order information, and the maintenance management data Lpk, which is data of a picking parts list equivalent to the corresponding parts list, is created. Then, a process of creating the part data Idpi related to each maintenance target item is repeated n times, which is a plurality of times, here, for example, 9 times for each item of the plurality of main parts P1 to P9.

In addition, a standard parts list is created for each model of the article inspection device 10. For example, part number candidates for the maintenance target part of a type suitable for the corresponding request category are prepared in order starting from the part number of the standard part for each maintenance target part Pi in the parts list, according to a plurality of requirement specification categories a to f shown in FIG. 4, and a requirement specification category is specified according to the content of the user requirement specifications at the time of ordering.

Therefore, as shown in FIG. 4, for any one part item Pi, for example, the transport belt P1 with item number (Im) "1", the requirement specification category is specified as, for example, a high grip force type or a material type category "c" suitable for the type of the article P, and the part number of the corresponding part is specified as the part identification code Npi. Alternatively, the requirement specification category for any one part item Pi, for example, the motor P5 with item number "5" is specified as a high-torque specification category c, and the part number of the corresponding part is specified as the part identification code Npi.

Further, the two-dimensional code Cd that is preset for each maintenance target part Pi in association with the part identification code Npi is specified at the same time as the part identification code Npi. Therefore, the two-dimensional code Cdi corresponding to the necessary part identification code Npi is selected and set for each part item Pi.

The control unit 12 further has a function of maintenance request information generation means 23 for generating, when the display control unit 22 displays and outputs the plurality of main parts P1 to P9 such that the parts can be selected using the maintenance target item as the item number, the part data Idpi, in which the machine number Mn is associated with the part identification code Npi of one main part (part Pi with item number Imi) selected from the plurality of main parts P1 to P9 being displayed and output, as maintenance request information and a function of maintenance request information output means 24 for displaying and outputting the part data Idpi as the maintenance request information associated with the machine number Mnb and/or transmitting and outputting the part data Idpi from a communication port 25 that can perform maintenance communication.

The internal DB 13 has a function of a maintenance management data storage unit that stores the maintenance management data Lpk equivalent to a parts list including the part identification code Npi of each of the plurality of main parts of the article inspection device 10.

The internal DB 13 stores manufacturing picking data used to pick at least the plurality of main parts P1 to P9 when the device is assembled at the manufacturer of the article inspection device 10, or manufacturing picking data used to pick all parts so as to be readable as the maintenance management data Lpk of the plurality of main parts P1 to P9 by a picking data input unit 111 on the manufacturer side (a maintenance management data input unit on the manufacturer side) and stores the manufacturing picking data as read-only information. In addition, the picking data input unit 111 can write the picking data to the internal DB 13 via the communication port 25 such that the picking data is stored as the maintenance management data Lpk of the plurality of main parts P1 to P9 in the internal DB 13, and the writing of the picking data can be performed via a communication network 200.

Further, when mounting parts of other main parts having the same purpose as the standard parts listed in the standard instruction manual, such optional parts replaceable from the standard parts or device-specific modified specification parts, are purchased and mounted after the use of the article inspection device 10 is started, the internal DB 13 can additionally write the maintenance management data of new mounted items to the maintenance management data Lpk, which is the list information of the mounted maintenance target parts, thereby storing the maintenance management data as read-only information. Then, in this case, the mounted maintenance target parts P1 to P9 and a new mounted item P10 associated with the machine number Mn are displayed and output such that the parts can be selected, based on the maintenance management data Lpk after the additional writing. Further, as shown in FIG. 3, other options, such as the standard parts that have not been mounted, may be displayed in a non-highlighted state. When an operation to request other options is input, other options, such as the standard parts that have not been mounted, may be displayed.

The EC site 101 has a function of authenticating the user and a payment function when parts are ordered using the part data Idpi and enables the user to order the parts.

The remote maintenance service site 102 is configured to specify the received part data Idpi as identification information (Npi+Mnb) of the actual mounted part, in which the part identification code Npi for which maintenance is requested is associated with the machine number Mnb of the article inspection device 10, when a support service or a remote maintenance service is requested as a maintenance request using the part identification code Npi and to determine whether or not the maintenance request information (Npi+Mnb) specified by the identification information can be accepted, based on the information stored in a received order information database (DB) 103 (a service part management database or a maintenance management database). Then, when the result of the determination shows that the maintenance request information can be accepted, a logistics system 150 is notified of received order information Iod including the part identification code Npi corresponding to the accepted maintenance request information (Npi+Mnb).

The EC site 101 and the remote maintenance service site 102 constitute a portion of a maintenance management system 100 for an article inspection device according to the present embodiment that maintains and manages the article inspection device 10.

The maintenance management system 100 has the picking data input unit 111 (maintenance management data input unit on the manufacturer side) that stores the maintenance management data Lpk corresponding to the picking data of the plurality of main parts P1 to P9 at the time of assembly at the manufacturer of the article inspection device 10 in the internal DB 13 of the article inspection device 10 in association with the machine number Mnb, which is the device identification information of the device shipped from the manufacturer, for each of the plurality of main parts P1 to P9.

In addition, the maintenance management system 100 has the remote maintenance service site 102 (a support service communication node on the manufacturer side or a specific part identification data acquisition unit) that acquires, when an operation to select one main part Pi from the plurality of main parts P1 to P9 as the maintenance target part and to specify the item number Imi of the selected main part is input via the article inspection device 10, as specific part identification data Npi, the part identification code Npi included in the maintenance management data Lpk which is stored in association with the machine number Mnb in the received order information DB 103 on the manufacturer side for the part identification code Npi of the selected main part Pi.

Further, the maintenance management system 100 includes the order information output means 24 for transmitting and outputting the part data Idpi using the specific part identification data Npi and the machine number Mnb as part order information from the article inspection device 10 to the remote maintenance service site 102 which is the support service communication node on the manufacturer side.

In addition, the maintenance management system 100 includes the remote maintenance service site 102 as a received order information generation unit that acquires the machine number Mnb and the specific part identification data Npi associated with the machine number Mnb when the remote maintenance service site 102 on the manufacturer side receives the part data Idpi using the part identification code Npi and the machine number Mnb included in the maintenance management data Lpk as the part order information as input and generates the received order information Iod corresponding to the part data Idpi when the acquired machine number Mnb and specific part identification data Npi are included in a plurality of sets of service machine number groups Mnbd and service part identification data groups Npd stored in the received order information DB 103 provided on the manufacturer side, and the logistics system 150 as a shipment determination unit that determines the shipment of a maintenance part having the same specifications as the specific maintenance part Pi actually equipped in the article inspection device 10, which is specified by the machine number Mnb, as a consumable part or a maintenance part purchased by the user, based on the machine number Mnb and the specific part identification data Npi included in the received order information Iod.

In addition, in the present embodiment, the article inspection device 10 in which the sorting unit 50 is disposed immediately after the inspection unit 30 is given as an example. However, the sorting unit 50 may not be provided. Further, the inspection unit 30 of an X-ray inspection type is given as an example. However, the inspection unit 30 may be a metal detection type that measures a change in magnetic field during the passage of the article, a weighting type that measures a load corresponding to the weight of the article during the passage of the article, an appearance inspection type based on a camera image, or the like.

The transport unit 40 includes the pre-stage conveyor 41, the inspection conveyor 42, and the sorting conveyor 43 that are disposed in a row in a left-right direction in FIG. 2, transport drive motors M1 and M2 for these conveyors, and a sorting drive actuator Vf. Each loop-shaped conveyor belt is supported by driving and driven rollers parallel to each other such that it can be driven to sequentially transport the articles P to the right direction in FIG. 1, which is not shown in detail. In addition, the transport drive units for the inspection conveyor 42 and the sorting conveyor 43 are configured to include a speed detection encoder and the like, in addition to the motors M1 and M2 for transport driving, and the inspection control unit 21 performs control such that the transport speed set for each type of article P is obtained.

The inspection unit 30 is an X-ray inspection unit including an X-ray generator 31 (X-ray source) that generates X-rays in a predetermined energy band transmitted through the article P transported by the transport unit 40 and an X-ray detector 33 that is disposed directly below a belt upper running section 42a of the inspection conveyor 42.

The X-ray generator 31 can generate X-rays having a wavelength and intensity corresponding to a tube current and a tube voltage of a known X-ray tube 32, using the X-ray tube 32, and can irradiate the article P in a predetermined inspection section on the inspection conveyor 42 with fan-beam X-rays which are spread in a direction orthogonal to an article transport direction of the transport unit 40, that is, in a scanning direction of the X-ray detector 33, through an X-ray window portion of an outer enclosure (not shown).

The X-ray detector 33 is, for example, an indirect-conversion-type X-ray line sensor using a scintillator, has, as detection elements, a plurality of photodiodes or charge coupled devices (CCDs) that receive scintillation light and are provided in an array at a predetermined pitch in a width direction of a transport path of the transport unit 40, and detects the X-rays at a predetermined resolution, which is not shown in detail.

The X-ray detector 33 is disposed at a predetermined position in the transport direction corresponding to an irradiation position of X-rays from the X-ray generator 31. That is, the X-ray detector 33 can detect the X-rays which have been emitted from the X-ray generator 31 and transmitted through the article P for each predetermined transmission region corresponding to the detection elements, convert the X-rays into an electric signal corresponding to the amount of transmission of the X-rays, and output an X-ray detection signal Lx for generating an X-ray transmission image in which a transmission direction of the X-rays is an observation direction.

In addition, the X-ray detector 33 is configured to execute line scanning in the width direction according to the transport speed of the inspection conveyor 42. When a pre-inspection article detection sensor 38 detects that the article P has been loaded onto the inspection conveyor 42, the inspection control unit 21 causes the X-ray detector 33 to repeat the line scanning at least during an X-ray imaging period (a transport direction length)/(a transport speed) of the article P through an X-ray image acquisition unit 35 and acquires the X-ray detection signal Lx for each scanning line. The pre-inspection article detection sensor 38 is configured as, for example, a photoelectric sensor that has an optical axis at a predetermined position on the inspection conveyor 42 in the transport direction and is shielded by the carried-in article P.

The inspection control unit 21 of the control unit 12 controls the X-ray irradiation intensity and irradiation period of the inspection unit 30 or controls, for example, the line scanning period of the X-ray detector 33 and the detection period of each article P corresponding to the transport speed of the article P, variably sets the output conditions of a sorting command signal RJ corresponding to the inspection result of the inspection unit 30 and the conditions of a sorting operation of the sorting unit 50 according to the type of the sorting command signal RJ and the type of the article P, and controls the conditions via an operation control unit 55 having a drive circuit provided therein.

A detailed configuration of the control unit 12 is not shown, but the control unit 12 is implemented by, for example, a combination of hardware, such as a microcomputer (processor) having a CPU, a ROM, a RAM, and an I/O interface, and software, such as a program, that exhibits various functions on the hardware. The hardware mentioned here may include a field programmable gate array (FPGA), a digital signal processor (DSP), a graphics processing unit (GPU), and the like. In addition, the various functions mentioned here are a plurality of functions for performing the acquisition and output of detection data capable of generating an X-ray image of the article P, the generation of inspection image data, predetermined image processing, an inspection determination process, display output control, and the like and further include a timer function and a software management function of storing a control program and a program module for implementing each function in a ROM, an auxiliary storage device, or another recording medium so as to be readable or downloading the control program or the program module from another computer using data communication.

The inspection control unit 21 of the control unit 12 stores a plurality of algorithms used for the inspection image processing as a modularized program and is configured to update or switch a program module, such as an image processing filter. An image processing filter P6 and the like can be included in the main parts referred to in the present invention.

The sorting unit 50 includes a support frame that supports the sorting conveyor 43, a pair of sorting members, for example, flipper arms 51 that are rotatably supported by the support frame and are located on both sides of the sorting conveyor 43 in the width direction of the transport path. In addition, the operation control unit 55 includes a pair of air cylinders, a lever member, a valve, and the like that independently control the sorting operation of the pair of flipper arms 51, which is not shown in detail. The constituent parts of the sorting unit 50 and the operation control unit 55 can also be included in the main parts according to the present invention. In addition, when the sorting unit 50 is provided with a pre-sorting article detection sensor, a good article passage detection sensor, a discharged defective article detection sensor, and the like, these parts can also be included in the main parts referred to in the present invention.

Next, a maintenance management method for an article inspection device according to an embodiment of the present invention will be described, and the operation of the present embodiment will be described.

### Procedure for Performing Maintenance Management

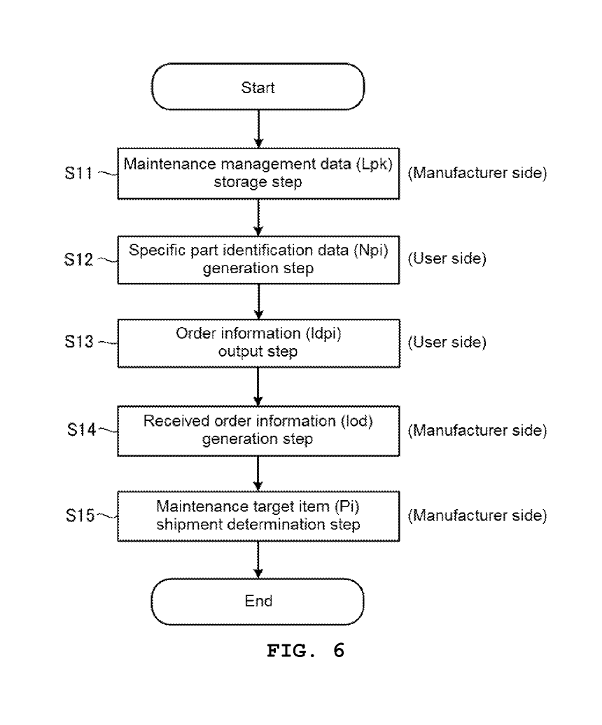

In the present embodiment, when the maintenance management method for the article inspection device 10 that measures a predetermined physical quantity of the transported article P and inspects the quality state of the article P based on the measured value of the physical quantity is used to quickly and accurately order the maintenance target parts, the maintenance management method according to the embodiment is executed in a rough processing procedure shown in FIG. 6.

First, a process in a maintenance management data storage step (Step S11) is executed that stores the maintenance management data of a plurality of main parts P1 to P9 at the time of assembly at the manufacturer of the article inspection device 10 in the internal DB 13 (non-volatile memory) provided inside the article inspection device 10 in association with the machine number Mnb which is the device identification information of the device shipped from the manufacturer.

Then, a process in a specific part identification data generation step (Step S12) is executed that generates, when an operation of selecting a specific main part from the plurality of main parts P1 to P9 in the article inspection device 10 as the maintenance target part is input from the user site 1, specific part identification data Npi capable of uniquely identifying the specific main part Pi selected as the maintenance target part, based on the maintenance management data Lpk stored in the internal DB 13 in association with the machine number Mnb in the maintenance management data storage step.

Then, a process in an order information output step (Step S13) is executed that transmits and outputs the part data Idpi as the part order information using the specific part identification data Npi and the machine number Mnb associated with the maintenance management data Lpk from the article inspection device 10 to the remote maintenance service site 102 which is the support service communication node on the manufacturer side.

Then, a process in a received order information generation step (Step S14) is executed that acquires the machine number Mnb and the specific part identification data Npi associated with the machine number Mnb included in the part data Idpi when the support service communication node on the manufacturer side, for example, the remote maintenance service site 102 receives the part data Idpi as the part order information as input, and generates the received order information Iod corresponding to the part data Idpi as the part order information when the acquired machine number Mnb and specific part identification data Npi are included in the service machine number group Mnbd and the service part identification data group Npd stored in the service part management database provided on the manufacturer side.

Then, a process in a shipment determination step (Step S15) is executed in which the logistics system 150 notified of the received order information Iod from the remote maintenance service site 102 picks up a maintenance part having the same specifications as the specific maintenance part Pi equipped in the article inspection device 10 specified by the machine number Mnb as a purchased consumable part or maintenance part, based on the machine number Mnb and the specific part identification data Npi included in the received order information Iod and determines the shipment of the consumable part or the maintenance part.

### Operation

In the article inspection device 10 according to the present embodiment, since the set values of various control parameters can change depending on the type of article, the article inspection device 10 is often customized to the form or function satisfying the specifications required by the production line, and the main parts P1 to P9 are often replaced with parts different from the standard parts.

Therefore, as shown in FIG. 3, first, for example, the part identification code Npi, the part name N, and the like of each maintenance target item are displayed in a list format, such as a list format of the plurality of main parts P1 to P9 of the article inspection device 10, together with the corresponding two-dimensional code Cd, in response to a touch panel operation input from the operation input means 11b.

Then, when the list equivalent to a parts list is displayed and output in this way, the plurality of main parts P1 to P9 are displayed and output such that the parts can be selected using the type of the maintenance target item as the item number.

However, the user can perform a selection input operation, for example, by moving a cursor or a highlighting display portion by a touch operation or an operation of movement operation keys 61, 62, 63, and 64 on the list display screen shown in FIG. 3 to specify the part item to be selected, without referring to the operation manual or instruction manual of the article inspection device 10 and then operating an OK button 65 to confirm the selection of the necessary maintenance target part item.

Then, when one specific maintenance target item Pi is selected, the part identification code Npi (part identification data) of the mounted part is accurately extracted even though the selected part is different from the standard part. In addition, the two-dimensional code Cd (which may be displayed to be enlarged at the time of the selection) is read by the information terminal 2 of the user site 1 or selected by a touch panel operation, which makes it is possible to perform connection to the EC site 101 or the remote maintenance service site 102 of the manufacturer and to quickly and accurately transmit the maintenance request of the user to the manufacturer such that the manufacturer can execute a quick and accurate response.

As described above, in the article inspection device 10 according to the present embodiment, even when any of the main parts P1 to P9 is customized to a part other than the standard part according to the specifications required by the user site 1, the user can easily and reliably understand the required maintenance target part Pi when the replacement of the worn or deteriorated consumable part is required or the replacement of other parts is required due to failure or functional degradation. Therefore, incorrect orders are reliably prevented.

In the present embodiment, the maintenance request information Idpi associated with the machine number Mnb is displayed and output and/or transmitted and output from the communication port 25 capable of performing maintenance communication and includes the display image of the two-dimensional code Cs that can be read by the information terminal or the like. Therefore, it is possible to quickly and accurately perform connection to the support service communication node on the manufacturer side, such as the EC site 101 or the remote maintenance service site 102 and to perform mutual communication.

Further, in the present embodiment, the picking data used when the device is assembled at the manufacturer is stored so as to be readable as the maintenance management data Lpk or is stored as read-only information in the internal DB 13. Therefore, it is possible to accurately list the main parts P1 to P9 to be maintained during mounting. Moreover, it is possible to write the initial maintenance management data Lpk to the internal DB 13 via the communication port 25, and when the mounted part is changed, it is possible to additionally write the changed part to the maintenance management data Lpk. Therefore, it is possible to easily and reliably understand the required maintenance target part Pi and to reliably prevent incorrect orders.

In addition, the maintenance management method according to the present embodiment includes: the maintenance management data storage step (S11) of storing the maintenance management data Lpk of the plurality of main parts P1 to P9 at the time of assembly at the manufacturer of the article inspection device 10 in the internal DB 13 in association with the machine number Mnb which is the device identification information of the device shipped from the manufacturer; the specific part identification data generation step (S12) of generating, when an operation of selecting the specific main part Pi from the plurality of main parts P1 to P9 as the maintenance target part is input, the specific part identification data Npi capable of uniquely identifying the specific main part Pi selected as the maintenance target part, based on the maintenance management data Lpk and the machine number Mnb stored in the internal DB 13; and the order information output step (S13) of transmitting and outputting the part order information Idpi using the specific part identification data Npi and the machine number Mnb from the article inspection device 10 to the remote maintenance service site 102 on the manufacturer side. Therefore, even when the plurality of main parts P1 to P9 are customized to parts other than the standard parts, the user can easily and reliably understand the worn and deteriorated consumable parts and other parts that need to be replaced, and the output (ordering) of incorrect order information is reliably prevented.

Further, in the present embodiment, the maintenance management method further includes: the received order information generation step (S14) of acquiring the machine number Mn and the specific part identification data Npi associated with the machine number Mn when the remote maintenance service site 102 on the manufacturer side receives the part order information Idpi as input and generating the received order information Iod corresponding to the part order information Idpi when the acquired machine number Mn and specific part identification data Npi are included in the service machine number group Mnbd and the service part identification data group Npd stored in the received order information DB 103 provided on the manufacturer side; and the shipment determination step (S15) of specifying a maintenance part having the same specifications as the specific maintenance part Pi specified by the machine number Mnb, based on the machine number Mnb and the specific part identification data Npi included in the received order information Iod, and determining the shipment of the maintenance part. Therefore, it is possible to effectively prevent an incorrect order receiving process and an incorrect shipment process.

Similarly, the maintenance management system according to the present embodiment includes: the picking data input unit 111 that stores the maintenance management data Lpk of the plurality of main parts P1 to P9 at the time of assembly at the manufacturer of the article inspection device 10 in the internal DB 13 and the received order information DB 103 on the manufacturer side in association with the machine number Mnb; the maintenance request information generation means 23 of the control unit 12 (a specific part identification data generation unit and a processing function unit in Step S12) for generating, when an operation of selecting the specific main part Pi from the plurality of main parts P1 to P10 as the maintenance target part is input via the article inspection device 10, the specific part identification data Npi capable of uniquely identifying the selected specific main part Pi based on the maintenance management data Lpk stored in association with the machine number Mnb; the maintenance request information output means 24 (an order information output unit and a processing function unit in Step S13) for transmitting and outputting the part data Idpi as the part order information using the specific part identification data Npi and the machine number Mnb from the article inspection device 10 to the remote maintenance service site 102 (support service communication node) on the manufacturer side; the remote maintenance service site 102 (a received order information generation unit and a processing function unit in Step S14) that acquires the machine number Mnb and the specific part identification data Npi when the support service communication node on the manufacturer side receives the part data Idpi as the part order information as input and generates the received order information Iod corresponding to the part data Idpi as the part order information when the machine number Mnb and the specific part identification data Npi are included in the service machine number group Mnbd and the service part identification data group Npd stored in the received order information DB 103 provided on the manufacturer side; and the logistics system 150 (a shipment determination unit and a processing function unit in Step S14) that specifies a maintenance part having the same specifications as the specific maintenance part Pi equipped in the article inspection device 10 specified by the machine number Mnb, based on the machine number Mnb and the specific part identification data Npi included in the received order information Iod, and determines the shipment of the maintenance part. Therefore, it is possible to effectively prevent an incorrect order receiving process or an incorrect shipment process.

As described above, in the present embodiment, even when any main part Pi is customized to a part other than the standard part according to the requirement specifications of the article inspection device 10, the user can easily and reliably understand the worn or deteriorated consumable part or other parts that need to be replaced. Therefore, incorrect orders are reliably prevented. As a result, it is possible to provide an article inspection device, a maintenance management method for the article inspection device, and a maintenance management system that can quickly and accurately respond to a maintenance request of the user.

In the above-described embodiment, the plurality of main parts which are the maintenance target parts are, for example, the transport belts, the rollers, the transport drive motors, other mounted parts of different types, the parts used for the sorting unit 50 and the operation control unit 55, and the like used in the article inspection device 10. However, the plurality of main parts can also include peripheral parts, such as conveyors, that are installed to extend.

In addition, when large functional parts, such as the X-ray tube 32 and the X-ray detector 33 of the article inspection device 10, are deteriorated, only a maintenance request may be required, without payment or with provisional payment. When it is clear that the part needs to be replaced based on wear detection or a usage time value, the part is considered to be the maintenance target part.

Further, in one of the typical embodiments of the present invention, the article inspection device 10 is an X-ray inspection type that measures the transmission intensity distribution of X-rays transmitted through the article P as a predetermined physical quantity of the article P. However, the present invention is not limited thereto. It goes without saying that the article inspection device 10 may be of a metal detection type that measures a change in magnetic field during the passage of the article, a weighting type that measures a load corresponding to the weight of the article during the passage of the article, an appearance inspection type based on a camera image, or the like.

As described above, the present invention can provide an article inspection device, a maintenance management method for the article inspection device, and a maintenance management system that can quickly and accurately respond to a maintenance request of a user. The present invention is also useful for an article inspection device, a maintenance management method for the article inspection device, and a maintenance management system in which replacement of consumable items or replacement of deteriorated or failed maintenance parts can be executed in an installation environment.

### DESCRIPTION OF REFERENCE NUMERALS AND SIGNS

1: User Site
2: Information Terminal (Tablet Information Terminal, Information Terminal For Checking Maintenance Parts On User Site)
10: Article Inspection Device
11: Display Operation Unit
11a: Display Means
11b: Operation Input Means
12: Control Unit
13: Internal Database (Maintenance Management Data Storage Unit)
21: Inspection Control Unit
22: Display Control Unit (Control Unit)
23: Maintenance Request Information Generation Means (Specific Part Identification Data Generation Unit)
24: Maintenance Request Information Output Means (Order Information Output Unit)
25: Communication Port
30: Inspection Unit
31: X-ray Generator
32: X-ray Tube
33: X-ray Detector
35: X-ray Image Acquisition Unit
38: Article Detection Sensor
40: Transport Unit
41: Pre-stage Conveyor (Conveyor)
42: Inspection Conveyor (Conveyor)
42a: Upper Running Section
43: Sorting Conveyor (Conveyor)
50: Sorting Unit
51: Flipper Arm
55: Operation Control Unit
65: Decision Button
100: Maintenance Management System
101: EC Site (Electronic Commerce Site, Support Service Communication Node)
102: Remote Maintenance Service Site (Support Service Communication Node, Specific Part Identification Data Acquisition Unit)
103: Received Order Information Database (Service Part Management Database, Maintenance Management Database)
111: Picking Data Input Unit (Maintenance Management Data Input Unit)
150: Logistics System (Shipment Determination Unit)
Cd: Two-Dimensional Code Dpx: Article Image
Idpi: Part Data (Part Order Information, Maintenance Request Information)
Im: Item Number (Item Number Indicating Maintenance Target Item)
Imi: Specific Item Number (Any One Item Number To Be Selected) Iod: Received Order Information
Lpk: Maintenance Management Data (Picking Data)
Lx: X-ray Detection Signal M1,
M2: Motor (Transport Drive Motor)
Mnb: Machine Number (Manufacturing Number, Device Identification Information)
Npi: Part Identification Code (Part Number, Specific Part Identification Data)
P: Article
Pi: Any One Part Item (Specific Part Item)
P1: Transport Belt (Main Part, Maintenance Target Part)
P2: Drive Roller (Main Part, Maintenance Target Part)
P3: Driven Roller (Main Part, Maintenance Target Part)
P4: Tension Roller (Main Part, Maintenance Target Part)
P5: Motor (Transport Drive Motor, Main Part, Maintenance Target Part)
P6: Filter (Main Part, Maintenance Target Part)
P7: Grease
P8: Key
P9: Screwdriver
P10: Changed Part (Maintenance Target Item That Has Not Been Mounted)
RJ: Sorting Command Signal
Vf: Sorting Drive Actuator

What is claimed is:

1. An article inspection device that measures a predetermined physical quantity of an article and inspects a quality state of the article based on a measured value of the physical quantity, the article inspection device comprising:
a display operation unit;
a maintenance management data storage unit that stores maintenance management data including part identification codes of a plurality of main parts, which constitute the article inspection device and are to be maintained, in association with a machine number which is device identification information of a device shipped from a manufacturer; and
a control unit that causes the display operation unit to display and output the plurality of main parts so as to be selectable as mounted maintenance target parts associated with the machine number, based on the maintenance management data stored in the maintenance management data storage unit, when display output of the maintenance management data is requested.

2. The article inspection device according to claim 1,
wherein the control unit includes
maintenance request information generation means for generating maintenance request information associated with the machine number, using a part identification code of a main part selected from the plurality of main parts being displayed and output on the display operation unit, and
maintenance request information output means for transmitting and outputting the maintenance request information associated with the machine number from a communication port capable of performing maintenance communication.

3. The article inspection device according to claim 1,
wherein the maintenance management data storage unit stores picking data used to pick the plurality of main parts when the device is assembled at the manufacturer so as to be readable as the maintenance management data of the plurality of main parts and stores the picking data as read-only information.

4. The article inspection device according to claim 2,
wherein the control unit connects the maintenance request information output means to a support service communication node of the manufacturer via the communication port and causes the maintenance request information output means to transmit and output the maintenance request information associated with the machine number, for the main part selected from the plurality of main parts, to the support service communication node.

5. The article inspection device according to claim 1,
wherein a distribution of a transmission amount of X-rays emitted to the transported article is measured as the predetermined physical quantity of the article, and the quality state of the article is inspected based on the distribution of the transmission amount.

6. The article inspection device according to claim 2,
wherein the maintenance management data storage unit stores picking data used to pick the plurality of main parts when the device is assembled at the manufacturer so as to be readable as the maintenance management data of the plurality of main parts and stores the picking data as read-only information.

7. The article inspection device according to claim 2,
wherein a distribution of a transmission amount of X-rays emitted to the transported article is measured as the predetermined physical quantity of the article, and the quality state of the article is inspected based on the distribution of the transmission amount.

8. A maintenance management method for an article inspection device that measures a predetermined physical quantity of an article and inspects a quality state of the article based on a measured value of the physical quantity, the maintenance management method comprising:
a maintenance management data storage step of storing maintenance management data of a plurality of main parts at a time of assembly at a manufacturer of the article inspection device in a non-volatile memory provided inside the article inspection device in association with a machine number which is device identification information of a device shipped from the manufacturer;
a specific part identification data generation step of generating, when an operation of selecting a specific main part from the plurality of main parts in the article inspection device as a maintenance target part is input, specific part identification data capable of uniquely identifying the specific main part selected as the maintenance target part, based on the maintenance management data stored in the non-volatile memory in association with the machine number in the maintenance management data storage step; and
an order information output step of transmitting and outputting part order information using the specific part identification data and the machine number associated with the maintenance management data from the article inspection device to a support service communication node on a side of the manufacturer.

9. The maintenance management method for an article inspection device according to claim 8, further comprising:
a received order information generation step of acquiring the machine number and the specific part identification data associated with the machine number when the support service communication node on the side of the manufacturer receives the part order information as input and generating received order information corresponding to the part order information when the acquired machine number and specific part identification data are included in a service machine number and service part identification data stored in a service part management database provided on the side of the manufacturer; and
a shipment determination step of determining shipment of a maintenance part having the same specifications as the specific maintenance part equipped in the article inspection device specified by the machine number, based on the machine number and the specific part identification data included in the received order information.

10. A maintenance management system for an article inspection device that measures a predetermined physical quantity of an article and inspects a quality state of the article based on a measured value of the physical quantity, the maintenance management system comprising:
a maintenance management data input unit that stores maintenance management data of a plurality of main parts at a time of assembly at a manufacturer of the article inspection device as maintenance management data associated with a machine number, which is device identification information of a device shipped from the manufacturer, in a non-volatile memory provided inside the article inspection device and in a maintenance management database on a side of the manufacturer;
a specific part identification data generation unit that generates, when an operation of selecting a specific main part among the plurality of main parts as a maintenance target part is input via the article inspection device, specific part identification data capable of uniquely identifying the specific main part selected as the maintenance target part, based on the maintenance management data stored in association with the machine number;
an order information output unit that transmits and outputs part order information using the specific part identification data and the machine number associated with the maintenance management data from the article inspection device to a support service communication node on a side of the manufacturer;
a received order information generation unit that acquires the machine number and the specific part identification data associated with the machine number when the support service communication node on the side of the manufacturer receives the part order information as input, and generates received order information corresponding to the part order information when the acquired machine number and specific part identification data are included in a service machine number and service part identification data stored in a service part management database provided on the side of the manufacturer; and
a shipment determination unit that determines shipment of a maintenance part having the same specifications as the specific maintenance part equipped in the article inspection device specified by the machine number, based on the machine number and the specific part identification data included in the received order information.
